(19) United States
(12) Patent Application Publication
(10) Pub. No.: US 2026/0161120 A1
(43) Pub. Date: Jun. 11, 2026

(54) IMAGE FORMING APPARATUS

(71) Applicant: Konica Minolta, Inc., Tokyo (JP)

(72) Inventor: Taizou OONISHI, Tokyo (JP)

(21) Appl. No.: 19/407,384

(22) Filed: Dec. 3, 2025

(30) Foreign Application Priority Data
Dec. 9, 2024 (JP) 2024-214238

(51) Int. Cl. G03G 15/20; G03G 15/00

(52) U.S. Cl. CPC G03G 15/2028; G03G 15/2064; G03G 15/657; G03G 15/6573; G03G 2215/00599

(57) ABSTRACT

An image forming apparatus includes a fixer that fixes a toner image formed on a sheet, a sensor that is provided on a downstream side of a fixing nip of the fixer in a sheet conveyance direction, and detects the sheet conveyed thereto, and a hardware processor that controls the fixer. Based on a detection result obtained by the sensor detecting a first sheet having passed through the fixer, the hardware processor controls the fixer such that a second sheet is conveyed at a predetermined conveyance speed, the second sheet being conveyed after the first sheet.

### CROSS-REFERENCE TO RELATED APPLICATIONS

The entire disclosure of Japanese Patent Application No. 2024-214238 filed on December 9, 2024, is incorporated herein by reference in its entirety.

### BACKGROUND OF THE INVENTION

### TECHNICAL FIELD

The present disclosure relates to an image forming apparatus.

### DESCRIPTION OF RELATED ART

Conventionally, there has been disclosed an image forming apparatus in which a sheet feeding speed is matched between a fixing heat roller and a sheet conveyance device on the upstream side of the fixing heat roller for the purpose of preventing wrinkling of the sheet and occurrence of transfer deviation (see Japanese Unexamined Patent Publication No. H6-230700).

### SUMMARY OF THE INVENTION

However, in the image forming apparatus disclosed in Japanese Unexamined Patent Publication No. H6-230700, entry of the leading end of the sheet into the fixing nip may not be performed smoothly depending on the posture of the leading end of the sheet. In such a case, as illustrated in FIG. 7, an unfixed image on the sheet may deform (reverse loop) in a direction approaching the fixing section. As a result, a problem arises that image unevenness occurs due to the unfixed image on the sheet being rubbed or thermally influenced before fixing.

The present disclosure has been made in view of the above problem, and an object of the present disclosure is to prevent occurrence of image unevenness caused by deformation of an unfixed image on a sheet in a direction approaching a fixing section.

To achieve at least one of the abovementioned objects, according to an aspect of the present disclosure, an image forming apparatus reflecting one aspect of the present disclosure includes:

a fixer that fixes a toner image formed on a sheet;

a sensor that is provided on a downstream side of a fixing nip of the fixer in a sheet conveyance direction, and detects the sheet conveyed thereto; and

a hardware processor that controls the fixer,

wherein based on a detection result obtained by the sensor detecting a first sheet having passed through the fixer, the hardware processor controls the fixer such that a second sheet is conveyed at a predetermined conveyance speed, the second sheet being conveyed after the first sheet.

### BRIEF DESCRIPTION OF THE DRAWINGS

The advantages and features provided by one or more embodiments of the present disclosure will become more fully understood from the detailed description given hereinbelow and the appended drawings which are given by way of illustration only, and thus are not intended as a definition of the limits of the present disclosure, wherein:

FIG. 1 is a schematic diagram showing an example of the configuration of an image forming apparatus of the present disclosure;

FIG. 2 is a block diagram illustrating a control system of the image forming apparatus of the present disclosure;

FIG. 3 illustrates peripheral components of a transfer section and a fixing section;

FIG. 4 is a flowchart illustrating a flow of a fixing speed control determination process;

FIG. 5 is a flowchart illustrating a flow of a second fixing speed control process;

FIG. 6 is a timing chart illustrating timing of sheet detection by a first sensor or a second sensor; and

FIG. 7 illustrates a state in which a sheet deformes in a direction in which the sheet approaches the fixing section.

### DETAILED DESCRIPTION

Hereinafter, one or more embodiments of the present disclosure will be described with reference to the drawings. However, the scope of the present disclosure is not limited to the disclosed embodiments.

The configuration and operation of an image forming apparatus according to an embodiment of the present disclosure will be described in detail with reference to the drawings. In the embodiment of the present disclosure, a color image forming apparatus will be described as an example, but the present disclosure is not limited thereto. For example, the present disclosure is also applicable to a monochrome image forming apparatus.

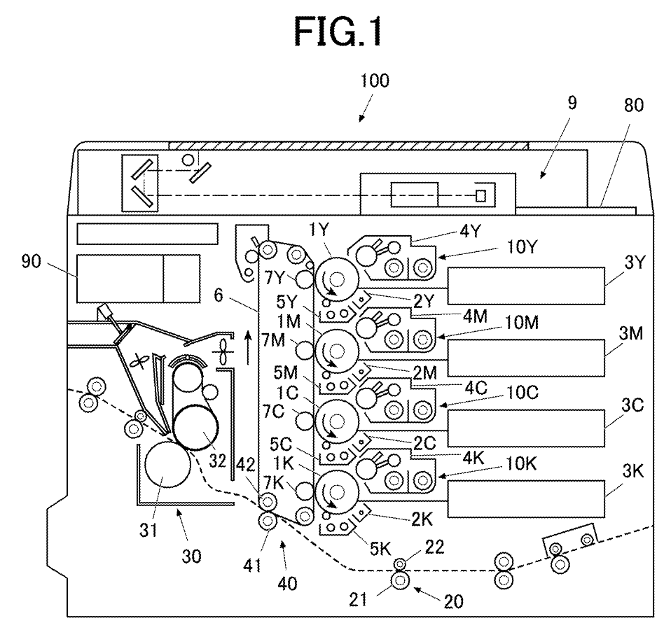

FIG. 1 is a schematic diagram which shows the configuration of an image forming apparatus 100 according to the present embodiment.

As shown in FIG. 1, the image forming apparatus 100 is also referred to as a tandem-type color image forming apparatus, and performs color image formation by four image forming sections 10. The image forming apparatus 100 performs image formation of image data on a sheet of a recording medium by using an image formation process of an electrophotographic method. The image forming apparatus 100 includes an image reading section 9, a sheet feed section 20, image forming sections 10, a transfer section 40 (conveyor), a fixing section 30 (fixer), an operation input section 80, a controller 90 (hardware processor), and the like. Note that a broken line illustrated in FIG. 1 represents a conveyance route of sheets.

The image reading section 9 scans and exposes an image of a document placed on a document plate by an optical system of a scanning exposure device, reads the image into a line image sensor, performs photoelectric conversion, and outputs an image information signal. The output image signal is subjected to analog processing, A/D conversion, shading correction, image compression processing, and the like in an image processing section (not illustrated), and is input to optical writing sections 3 of the image forming sections 10.

An operation input section 80 is provided in the vicinity of the image reading section 9. The user can set image formation settings, a sheet size, the number of sheets for printing, and the like via the operation input section 80.

The sheet feed section 20, the image forming sections 10, an intermediate transfer belt 6, the transfer section 40, the fixing section 30, and the like are disposed below the image reading section 9.

As the image forming sections 10, an image forming section 10Y that forms a yellow (Y) image is provided. Further, an image forming section 10M that forms a magenta (M) color image is provided. Further, an image forming section 10C that forms a cyan (C) image is provided. Further, an image forming section 10K that forms a black (K) image is provided. That is, as the image forming sections 10, a total of four image forming sections of the image forming section 10Y, the image forming section 10M, the image forming section 10C, and the image forming section 10K are provided.

The image forming section 10Y includes a photosensitive drum 1Y as an image bearing member, and a charging section 2Y, an optical writing section 3Y, a developing section 4Y, and a photosensitive drum cleaning section 5Y which are arranged around the photosensitive drum 1Y. Similarly, the image forming section 10M includes a photosensitive drum 1M as an image bearing member, and a charging section 2M, an optical writing section 3M, a developing section 4M, and a photosensitive drum cleaning section 5M which are arranged around the photosensitive drum 1M. The image forming section 10C includes a photosensitive drum 1C as an image bearing member, and a charging section 2C, an optical writing section 3C, a developing section 4C, and a photosensitive drum cleaning section 5C which are arranged around the photosensitive drum 1C. The image forming section 10K includes a photosensitive drum 1K as an image bearing member, and a charging section 2K, an optical writing section 3K, a developing section 4K, and a photosensitive drum cleaning section 5K which are arranged around the photosensitive drum 1K. Note that of the image forming sections 10Y, 10M, 10C, 10K, the photosensitive drums 1Y, 1M, 1C, 1K have the same function, the charging sections 2Y, 2M, 2C, 2K have the same function, the optical writing sections 3Y, 3M, 3C, 3K have the same function, and the photosensitive drum cleaning sections 5Y, 5M, 5C, 5K have same function. Therefore, they are denoted without the reference signs Y, M, C, and K unless otherwise particularly specified.

Each image forming section 10 writes an image information signal on the photosensitive drum 1 with the optical writing section 3 to form a latent image on the photosensitive drum 1 based on the image information signal. Then, the latent image is developed by the developing section 4 to form a toner image, which is a visible image, on the photosensitive drum 1.

The intermediate transfer belt 6 is an endless belt, and is supported by a plurality of rollers so as to be able to travel. The toner images of the respective colors formed by the image forming sections 10Y, 10M, 10C, and 10K are sequentially transferred onto the traveling intermediate transfer belt 6 by primary transfer sections 7Y, 7M, 7C, and 7K, and a color image (toner image) in which the layers of the respective colors are superimposed is primarily transferred onto the intermediate transfer belt 6.

The sheet feed section 20 includes a feed roller 21 and a counter roller 22. The sheet feed section 20 conveys a sheet supplied from a sheet feed tray (not shown) or from the outside of the image forming apparatus 100, and supplies the sheet to the transfer section 40.

The transfer section 40 includes a transfer roller 41 and a transfer counter roller 42. The transfer roller 41 is disposed in contact with the transfer counter roller 42 via the intermediate transfer belt 6, and the toner image on the intermediate transfer belt 6 is secondarily transferred to the sheet as the sheet passes through a transfer nip formed between the transfer roller 41 and the transfer counter roller 42.

The fixing section 30 is disposed on the downstream side of the sheet at the transfer roller 41. The fixing section 30 includes a fixing roller 31 and a heating roller 32. In the fixing section 30, the sheet passes through a fixing nip formed between the fixing roller 31 and the heating roller 32, so that the sheet is heated and pressurized to fix the transferred toner image on the sheet. Further, the fixing section 30 fixes the toner image onto the sheet, and conveys the sheet to the downstream side in a sheet conveyance direction.

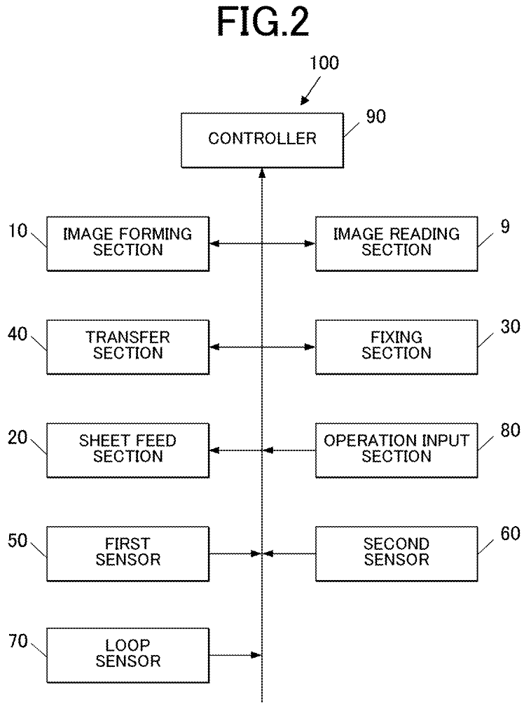

As shown in FIG. 2, the components of the image forming apparatus 100 are connected to the controller 90, and are appropriately controlled by the controller 90. The controller 90 includes a central processing unit (CPU), a random access memory (RAM), and a read only memory (ROM), which are not illustrated.

The controller 90 performs various actions in accordance with various process programs for the image forming apparatus 100. Note that the image forming apparatus 100 may include constituent elements other than the above-described constituent elements, or may not include some of the above-described constituent elements.

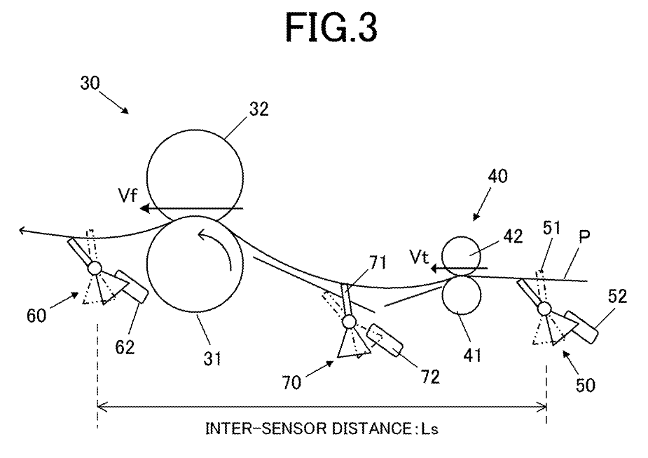

Next, peripheral components around the transfer section 40 and the fixing section 30 will be described with reference to FIG. 3.

FIG. 3 illustrates peripheral components around the transfer section 40 and the fixing section 30.

As shown in FIG. 3, at a predetermined position on the upstream side of the transfer section 40 in the sheet conveyance direction, a first sensor 50 that detects the leading end or the trailing end of a sheet P is provided. Similarly, at a predetermined position on the downstream side of the fixing section 30 in the sheet conveyance direction, a second sensor 60 that detects the leading end or the trailing end of the sheet P is provided. The first sensor 50 includes an arm portion (actuator) 51, a laser sensor 52, and the like. When the leading end of the sheet P conveyed from the upstream side in the sheet conveyance direction abuts on the arm portion 51 and thus the arm portion 51 is inclined, and the laser sensor 52 detects this inclination, the sensor 50 can determine that the sheet P has started to pass through the first sensor 50. That is, the first sensor 50 detects the leading end of the sheet P by detecting the inclination of the arm portion 51 with the laser sensor 52. Further, when the trailing end of the sheet P passes through and does not abut on the arm portion 51 any longer, the arm portion 51 returns to the original position, and the laser sensor 52 does not detect the inclination of the arm portion 51 any longer, the first sensor 50 can determine that the sheet P has passed through the first sensor 50. That is, the first sensor 50 detects the trailing end of the sheet P when the laser sensor 52 no longer detects the inclination of the arm portion 51. Since the second sensor 60 has the same configuration as the first sensor 50, the description of the second sensor 60 will be omitted.

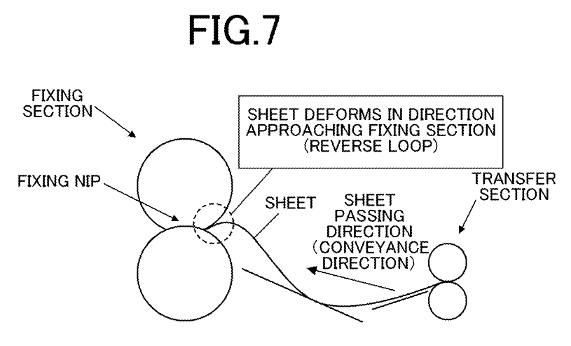

A loop sensor 70 (loop detector) is provided between the transfer section 40 and the fixing section 30. The loop sensor 70 is a sensor for determining whether the posture of the sheet P passing between the transfer section 40 and the fixing section 30 is appropriate. The loop sensor 70 includes an arm portion 71 and a laser sensor 72. When the degree of the loop (curved shape) formed in the sheet P exceeds a threshold value, the arm portion 71 is inclined, and this inclination is detected by the laser sensor 72, whereby the loop sensor 70 can determine that the posture of the sheet P is no longer appropriate. That is, the loop sensor 70 detects the sheet P by detecting the inclination of the arm portion 71 with the laser sensor 72. The state in which the posture of the sheet P is no longer appropriate includes the state of the reverse loop illustrated in FIG. 7. On the other hand, in the normal state where the posture of the sheet P is in an appropriate state, the loop sensor 70 can determine that the posture of the sheet P is in an appropriate state because the inclination of the arm portion 71 is not detected by the laser sensor 72.

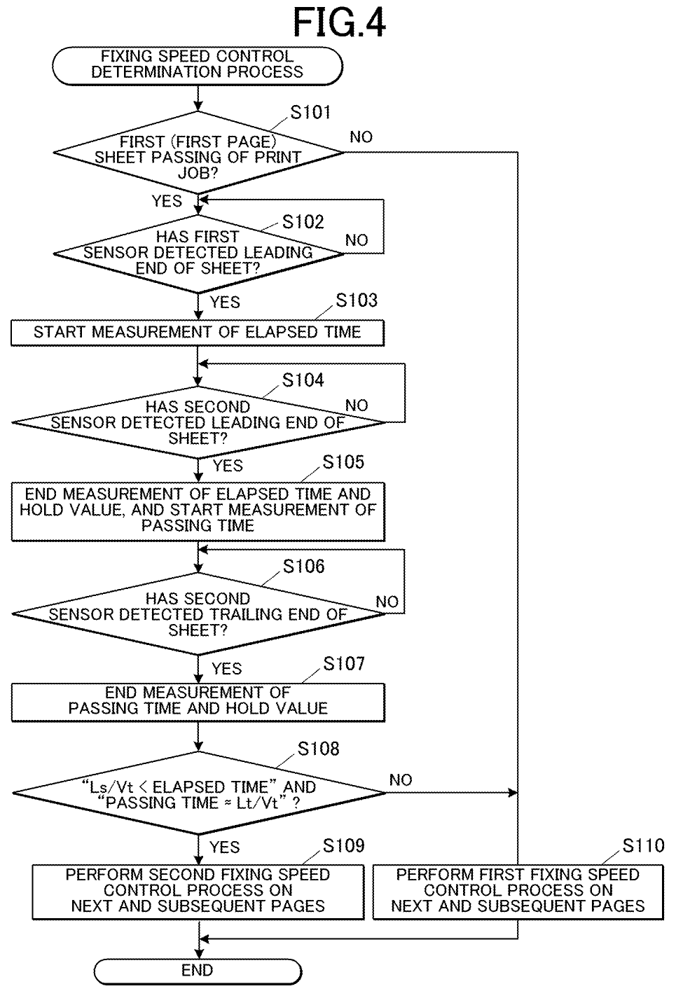

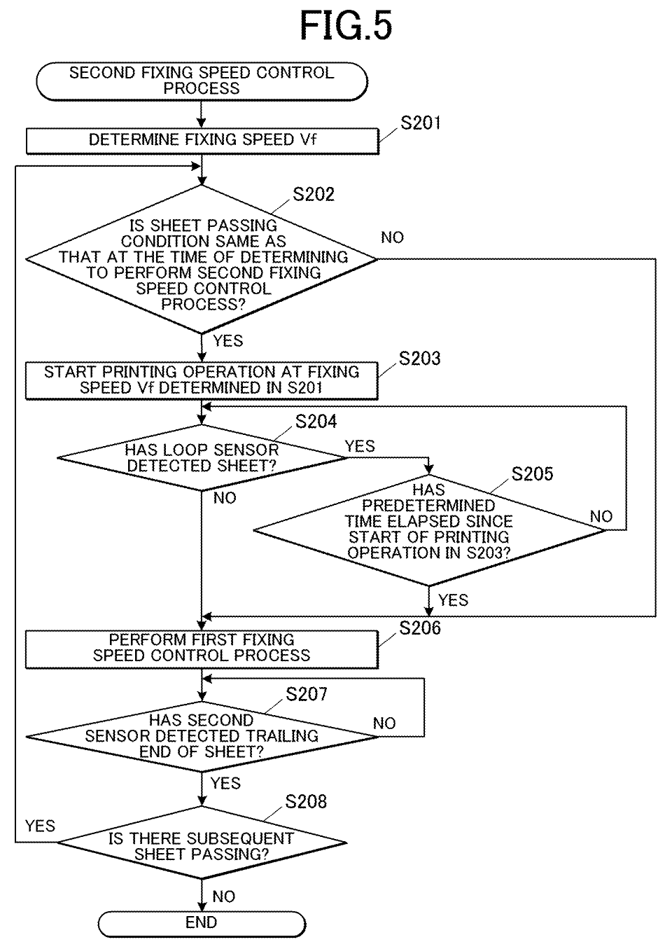

Next, the operation of the image forming apparatus 100 will be described with reference to FIG. 4 and FIG. 5.

FIG. 4 is a flowchart illustrating the flow of a fixing speed control determination process. The fixing speed control determination process is performed by the CPU and a fixing speed control determination program stored in the ROM of the controller 90 of the image forming apparatus 100 in cooperation with one another. The fixing speed control determination process is started when a print start request is obtained by the controller 90.

As shown in FIG. 4, when the fixing speed control determination process is started, first, the controller 90 determines whether the first (first page) sheet passing of the print job is performed (Step S101). Here, in a case where the print job is a mixed job in which multiple paper types are mixed, the controller 90 determines whether the first sheet passing is performed for each paper type. For example, in the case of a mixed job in which thin paper and thick paper are mixed, and the first page of the mixed job is thin paper and the second page is thick paper, the controller 90 determines both the first page of the thin paper and the second page of thick paper as the first sheet passing.

If it is determined in Step S101 that the first sheet passing of the print job is not performed, that is, sheet passing of the second or subsequent page is performed (Step S101; NO), the controller 90 advances the process to Step S110. Then, the controller 90 determines to perform the normal fixing speed control process, that is, a first fixing speed control process, on the next and subsequent pages (Step S110). Then, the controller 90 ends the fixing speed control determination process.

If it is determined in Step S101 that the first sheet passing of the print job is performed (Step S101; YES), the controller 90 determines whether the leading end of the passing sheet has been detected by the first sensor 50 (Step S102).

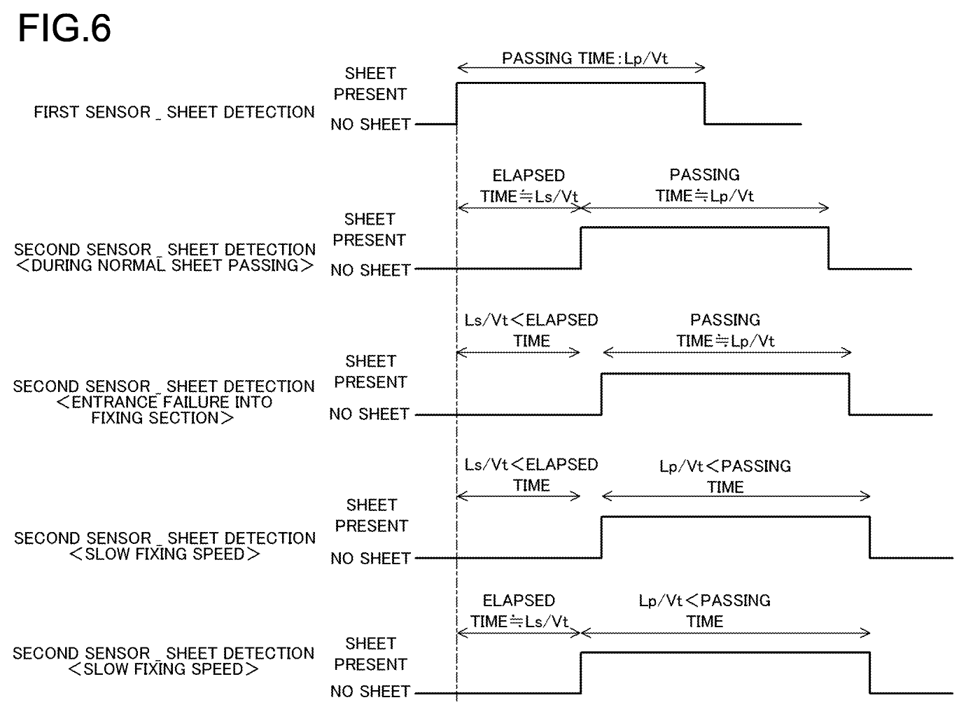

If it is determined in Step S102 that the leading end of the sheet has not been detected (Step S102; NO), the controller 90 performs the determination process in Step S102 again. On the other hand, if it is determined in Step S102 that the leading end of the sheet has been detected (Step S102; YES), the controller 90 starts to measure the elapsed time (Step S103). The elapsed time means the time from when the first sensor 50 detects the leading end of the sheet to when the second sensor 60 detects the leading end of the sheet (see the second to fifth rows from the top in the timing chart of FIG. 6).

Next, the controller 90 determines whether the second sensor 60 has detected the leading end of the sheet (Step S104).

If it is determined in Step S104 that the leading end of the sheet has not been detected (Step S104; NO), the controller 90 performs the determination process in Step S104 again. On the other hand, if it is determined in Step S104 that the leading end of the sheet has been detected (Step S104; YES), the controller 90 advances the process to Step S105. Then, the controller 90 ends the measurement of the elapsed time, holds the value of the elapsed time, and starts the measurement of the passing time (Step S105). The passing time means the time during which the sheet is passing through the second sensor 60. In other words, the passing time means the time from when the leading end of the sheet is detected to when the trailing end of the sheet is detected by the second sensor 60 (see the second to fifth rows from the top in the timing chart of FIG. 6).

Next, the controller 90 determines whether the trailing end of the sheet has been detected by the second sensor 60 (Step S106).

If it is determined in Step S106 that the trailing end of the sheet has not been detected (Step S106; NO), the controller 90 performs the determination process in Step S106 again. On the other hand, if it is determined in Step S106 that the trailing end of the sheet has been detected (Step S106; YES), the controller 90 advances the process to Step S107. Then, the controller 90 ends the measurement of the passing time and holds the value of the passing time (Step S107).

Next, the controller 90 compares the value of the elapsed time held in Step S105 with the value (Ls/Vt) obtained by dividing the distance Ls between the first sensor 50 and the second sensor 60 (inter-sensor distance) by the conveyance speed Vt in the transfer section 40 (Step S108). Further, the controller 90 compares the value of the passing time held in Step S107 with the value (Lp/Vt) obtained by dividing the length Lp of the sheet in the sheet passing direction by the conveyance speed Vt (Step S108).

In Step S108, when the value of the elapsed time is larger than Ls/Vt and the value of the passing time is equivalent to (i.e., ≈ or ≒; the same applies hereinafter) Lp/Vt (Step S108; YES), the controller 90 advances the process to Step S109. Then, the controller 90 determines to perform the fixing speed control process of the present disclosure, that is, the second fixing speed control process, on the next and subsequent pages (Step S109). That is, as illustrated in the third row from the top in the timing chart of FIG. 6, when the sheet arrival at the second sensor 60 is delayed and the value of the passing time is equivalent to Lp/Vt, the cause is not the conveyance speed (Vf) in the fixing section 30 but the delay of the sheet arrival at the fixing nip (fixing section 30) (entrance failure into the fixing section), so that the controller 90 determines to perform the second fixing speed control process. Then, the controller 90 ends the fixing speed control determination process.

In Step S108, when the condition that the value of the elapsed time is larger than Ls/Vt and the value of the passing time is equivalent to Lp/Vt is not satisfied (Step S108; NO), the controller 90 advances the process to Step S110. Then, the controller 90 determines to perform the normal fixing speed control process, that is, the first fixing speed control process, on the next and subsequent pages (Step S110). Specifically, as illustrated in the second row from the top in the timing chart of FIG. 6, when the value of the elapsed time is equivalent to Ls/Vt and the value of the passing time is equivalent to Lp/Vt (in the case of normal sheet passing), the controller 90 determines to perform the first fixing speed control process. As illustrated in the fourth row from the top in timing chart of FIG. 6, when the sheet arrival at the second sensor 60 is delayed and the value of the passing time is larger than Lp/Vt (when the fixing speed (Vf) is low), the controller 90 determines to perform the first fixing speed control process. Further, as illustrated in the fifth row from the top in the timing chart of FIG. 6, when the value of the elapsed time is equivalent to Ls/Vt and the value of the passing time is larger than Lp/Vt (when the fixing speed (Vf) is low), the controller 90 determines to perform the first fixing speed control process. Then, the controller 90 ends the fixing speed control determination process.

The above-described conveyance speed Vt varies depending on the pressure of the transfer nip in the transfer section 40, the outer diameters of the transfer roller 41 and the transfer counter roller 42, the state of the sheet (thickness, surface roughness, material), and the like. Further, the inter-sensor distance Ls (see FIG. 3) varies depending on the state of the sheet (basis weight, humidity conditioning) and the like. Therefore, for the determination of whether the value of the elapsed time is larger than Ls/Vt, the accuracy of the determination can be ensured by measuring the variation in these variation factors in advance and comparing it with the upper limit value. Further, by using the measurement value in the past in which sheet passing has been performed under the conditions of the same paper type and mode (first side/second side in double-sided sheet passing, etc.) as those of the above-described sheet and comparing it with the maximum value thereof, it is possible to make a more precise determination for each product according to the status of use. Further, by setting a reference value for the determination to a value corresponding to the paper type (basis weight or the like), it is possible to further improve the accuracy of the determination. Further, whether the value of the passing time is equivalent to Lp/Vt is determined based on a variation range (about Vt ± 0.5 to 1%) of the conveyance speed Vt which is a fluctuation factor, and if the value is within the range, it is determined that they are equivalent (the same applies to the elapsed time).

FIG. 5 is a flowchart illustrating the flow of the above-described second fixing speed control process. The second fixing speed control process is performed by the CPU and a second fixing speed control program stored in the ROM of the controller 90 of the image forming apparatus 100 in cooperation with one another. The second fixing speed control process is started when the determination to perform the second fixing speed control process is made and sheet passing of the next or subsequent page is started in Step S109 of the above-described fixing speed control determination process.

As shown in FIG. 5, when the second fixing speed control process is started, first, the controller 90 determines the fixing speed Vf (see FIG. 3) which is the conveyance speed in the fixing section 30 (Step S201). Specifically, the controller 90 determines a speed of +1.0 to +2.0% with respect to the conveyance speed Vt in the transfer section 40 as the fixing speed Vf. Note that this determination method is merely an example. For example, the fixing speed Vf may be determined in accordance with the value of the elapsed time held in Step S105 of the above-described fixing speed control determination process. Specifically, the determination is made such that the fixing speed Vf increases as the value of the elapsed time increases. Thus, the reverse loop that occurs in the sheet passing through between the transfer section 40 and the fixing section 30 can be eliminated, and image shift in the transfer section 40 due to excessive pulling of the sheet can be prevented. Alternatively, the fixing speed Vf may be determined in accordance with the value of the aforementioned passing time held in Step S107 of the fixing speed control determination process in addition to the value of the aforementioned elapsed time. Specifically, the determination is made such that the fixing speed Vf increases as the value of the elapsed time increases and the fixing speed Vf increases as the value of the passing time increases. This is because as the elapsed time is longer, the entrance of the leading end of the sheet into the fixing nip is slower and the reverse loop is larger, as the passing time is longer, the conveyance speed at the fixing nip is slower, and as these are in an overlapping state, the fixing speed Vf needs to be increased. Thus, the reverse loop that occurs in the sheet passing through between the transfer section 40 and the fixing section 30 can be more suitably eliminated, and image shift in the transfer section 40 due to excessive pulling of the sheet can be more suitably prevented.

Next, the controller 90 determines whether the condition of the currently performed sheet passing (sheet passing condition) is the same as the sheet passing condition when it is determined to perform the second fixing speed control process in Step S109 of the above-described fixing speed control determination process (Step S202). The sheet passing condition includes, for example, conditions relating to sheet information (stiffness, basis weight, volume resistance, humidity conditioning state by environment, and the like), image information (image area, toner amount distribution, and the like), and mode information (single-sided/double-sided, high speed/low speed, and the like). In the present embodiment, when at least one of the conditions related to the sheet information, the image information, and the mode information is the same, it is determined that the condition of the currently performed sheet passing and the sheet passing condition when it is determined to perform the second fixing speed control process are the same.

When it is determined in Step S202 that the condition of the currently performed sheet passing and the sheet passing condition when it is determined to perform the second fixing speed control process are not the same (Step S202; NO), the controller 90 advances the process to Step S206.

When it is determined in Step S202 that the condition of the currently performed sheet passing and the sheet passing condition when it is determined to perform the second fixing speed control process are the same (Step S202; YES), the controller 90 advances the process to Step S203. Then, the controller 90 starts the printing operation at the fixing speed Vf determined in Step S201 (Step S203). The control at the fixing speed Vf is switched between after the trailing end of the sheet (first sheet) that was subjected to sheet passing when it was determined to perform the second fixing speed control process passes through the fixing nip and before the leading end of the sheet (second sheet) of the next page reaches the fixing nip. Thus, it is possible to prevent sheet passing influence (image noise, wrinkles, and the like) at the time of speed change.

Next, the controller 90 determines whether a sheet has been detected by the loop sensor 70 (Step S204).

If it is determined in Step S204 that no sheet has been detected by the loop sensor 70 (Step S204; NO), the controller 90 advances the process to Step S206.

Further, if it is determined in Step S204 that a sheet has been detected by the loop sensor 70 (Step S204; YES), the controller 90 determines whether a predetermined time has elapsed since the start of the printing operation in Step S203 (Step S205). The predetermined time is, for example, a time calculated by the following: (Δt×Vt)/Vf. Δt is a difference between Ls/Vt and the above-described elapsed time.

If it is determined in Step S205 that the predetermined time has not elapsed since the start of the printing operation in Step S203 (Step S205; NO), the controller 90 returns the process to Step S204 and repeats the process in Step S204 and subsequent processes.

If it is determined in Step S205 that the predetermined time has elapsed since the start of the printing operation in Step S203 (Step S205; YES), the controller 90 advances the process to Step S206.

Next, the controller 90 performs the first fixing speed control process (Step S206). In the first fixing speed control process, the fixing speed is controlled according to the conveyance speed Vt in the transfer section 40. In the first fixing speed control process, so-called loop control may be performed in which the fixing speed is switched to high speed/low speed with respect to the conveyance speed Vt in the transfer section 40 based on the detection result of the sheet by the loop sensor 70.

Next, the controller 90 determines whether the trailing end of the currently passing sheet has been detected by the second sensor 60 (Step S207).

When it is determined in Step S207 that the trailing end of the currently passing sheet has not been detected by the second sensor 60 (Step S207; NO), the controller 90 performs the determination process in Step S207 again. On the other hand, when it is determined in Step S207 that the trailing end of the currently passing sheet has been detected by the second sensor 60 (Step S207; YES), the controller 90 advances the process to Step S208.

Next, the controller 90 determines whether there is subsequent sheet passing (Step S208).

If it is determined in Step S208 that there is subsequent sheet passing (Step S208; YES), the controller 90 returns the process to Step S202, and repeats the possess in Step S202 and the subsequent processes.

If it is determined in Step S208 that there is no subsequent sheet passing (Step S208; NO), the controller 90 ends the second fixing speed control process.

As described above, the image forming apparatus 100 includes the fixing section 30 that fixes a toner image formed on a sheet, the second sensor 60 that is provided on the downstream side of the fixing nip of the fixing section 30 in the conveyance direction of the sheet and detects the sheet conveyed thereto, and the controller 90 that controls the fixing section 30. The controller 90 controls the fixing section 30, based on a detection result obtained by the second sensor 60 detecting a first sheet having passed through the fixing section 30 such that a second sheet is conveyed at a predetermined conveyance speed, the second sheet being conveyed after the first sheet. Specifically, the controller 90 controls the fixing section 30 such that the second sheet is conveyed at a predetermined conveyance speed for a certain period of time after the second sheet enters the fixing nip of the fixing section 30.

Therefore, according to the image forming apparatus 100, since the sheet entrance failure into the fixing nip can be predicted based on the detection result by the second sensor 60, the fixing section 30 can be controlled such that the deterioration (reverse loop) of the sheet posture due to the sheet entrance failure is eliminated in the sheet passing of the second sheet and the subsequent sheets. As a result, it is possible to prevent occurrence of image unevenness caused by deformation of the unfixed image on the passed sheet in the direction in which the unfixed image approaches the fixing section 30.

The above-mentioned certain period of time during which the fixing section 30 is controlled by the controller 90 is, for example, a time during which a sheet length which is likely to be a reverse loop is predicted from a delay of a time at which the sheet reaches the second sensor 60, and the reverse loop of the sheet length is eliminated. Alternatively, the above-mentioned certain period of time may be a time until the reverse loop is eliminated and the loop sensor 70 detects the absence of the sheet. Alternatively, the above-mentioned certain period of time may be the same time as the delay ΔT of the time when the leading end of the sheet reaches the second sensor 60. Alternatively, data on a predetermined time may be stored for each paper type/mode, and the above-mentioned certain period of time may be a time selected from the data in accordance with conditions.

The image forming apparatus 100 further includes the transfer section 40 (conveyor) that conveys the sheet to the fixing section 30. The controller 90 controls the fixing section 30 such that the second sheet to be conveyed after the first sheet is conveyed at the predetermined conveyance speed Vf higher than the conveyance speed Vt in the transfer section 40 for a certain period of time after the second sheet enters the fixing nip of the fixing section 30.

According to the image forming apparatus 100, the conveyance speed (fixing speed) Vf in the fixing section 30 is controlled to be a speed faster than the conveyance speed Vt in the transfer section 40, so that in the sheet passing of the second sheet and subsequent sheets, the deterioration of the sheet posture due to the sheet entrance failure into the fixing nip can be promptly and effectively eliminated.

Note that the conveyance speed (fixing speed) Vf in the fixing section 30 is preferably switched to the conveyance speed Vf determined based on the detection result by the second sensor 60, before the leading end of the second sheet enters the fixing nip. This is because it is possible to suitably prevent a problem that the effect of the present disclosure is reduced due to variation in timing at which the sheet enters the fixing nip. Further, the conveyance speed Vf in the fixing section 30 can be made variable in accordance with the detection result by the second sensor 60.

Further, the image forming apparatus 100 includes an obtaining unit (controller 90) that obtains sheet information, image information, and mode information for each sheet that is conveyed. When at least one of the sheet information, the image information, and the mode information is identical between the second sheet and the first sheet, the controller 90 controls the fixing section 30.

Therefore, according to the image forming apparatus 100, since it is possible to prevent the conveyance speed (fixing speed) Vf in the fixing section 30 from being unnecessarily changed, it is possible to prevent image shift due to pulling of the sheet in the transfer section 40 or image unevenness due to insufficient elimination of the reverse loop.

The image noise due to the sheet entrance failure into the fixing nip is influenced by the posture and the shape of the leading end of the sheet entering the fixing nip and sheet passing conditions. That is, the position of the sheet relative to the fixing nip position, the likelihood of occurrence of the reverse loop when the above-described sheet entrance failure occurs, the degree of image unevenness when the reverse loop occurs, and the like change by the sheet information (stiffness, basis weight, volume resistance, humidity conditioning state by environment, and the like), the image information (image area, toner amount distribution, and the like), and the mode information (single-sided/double-sided, high speed/low speed, and the like). Therefore, in the present embodiment, the above-described each information is obtained, and only when it matches the condition to change the conveyance speed (fixing speed) Vf in the fixing section 30, the conveyance speed (fixing speed) Vf is changed. Note that an example of the case where at least one of the sheet information, the image information, and the mode information is identical between the second sheet and the first sheet is a case where continuous sheet passing is performed from the same sheet feed tray (cassette). Another example is a case where the second sheet and the first sheet have substantially the same image. Another example is a case where the conditions of the first side and the second side of the double-sided printing match.

Further, the image forming apparatus 100 includes the loop sensor 70 (loop detector) that is provided between the fixing section 30 and the transfer section 40 (conveyor) and detects the curved shape (reverse loop) of the sheet that passes through between the fixing section 30 and the transfer section 40. The controller 90 controls the fixing section 30 during a period from when the sheet enters the fixing nip of the fixing section 30 to when the loop sensor 70 detects that the curve of the sheet is eliminated.

Therefore, according to the image forming apparatus 100, it is possible to end, at an appropriate timing, the sheet passing in the state where the conveyance speed has been changed to the predetermined conveyance speed Vf that is higher than the conveyance speed Vt in the transfer section 40. As a result, according to the image forming apparatus 100, it is possible to proceed to the normal sheet passing control at an appropriate timing after the conveyance speed is changed to the predetermined conveyance speed Vf that is higher than the conveyance speed Vt in the transfer section 40.

Further, the controller 90 controls the fixing section 30 so as to keep the conveyance at a set fixing speed Vf until a period calculated from the detection result by the second sensor 60 on the downstream side of the fixing nip of the fixing section 30 and a speed higher than the conveyance speed Vt of the transfer section 40 elapses.

Therefore, according to the image forming apparatus 100, it is possible to end, at an appropriate timing, the sheet passing in the state where the conveyance speed has been changed to the predetermined conveyance speed Vf that is higher than the conveyance speed Vt in the transfer section 40. As a result, according to the image forming apparatus 100, it is possible to proceed to the normal sheet passing control at an appropriate timing after the conveyance speed is changed to the predetermined conveyance speed Vf that is higher than the conveyance speed Vt in the transfer section 40.

Further, the controller 90 determines whether to control the fixing section 30 based on the time from the timing at which the sheet passes through the transfer section 40 to the timing at which the sheet reaches the second sensor 60 on the downstream side of the fixing nip and the time during which the sheet is passing through the second sensor 60 on the downstream side of the fixing nip. In other words, the controller 90 determines whether to perform the second fixing speed control process (see FIG. 5).

Therefore, according to the image forming apparatus 100, it is possible to accurately detect whether a sheet entrance failure into the fixing nip has occurred, based on the elapsed time from the timing at which the sheet passes through the transfer section 40 to the timing at which the sheet reaches the second sensor 60 on the downstream side of the fixing nip, and the passing time during which the sheet is passing through the second sensor 60 on the downstream side of the fixing nip. As a result, according to the image forming apparatus 100, it is possible to determine to perform the second fixing speed control process in the situation in which a sheet entrance failure into the fixing nip has occurred, and therefore it is possible to appropriately control the conveyance speed (fixing speed) Vf in the fixing section 30.

Further, if the time from the timing at which the sheet passes through the transfer section 40 to the timing at which the sheet reaches the second sensor 60 on the downstream side of the fixing nip is longer than the predetermined time and the time during which the sheet is passing through the second sensor 60 on the downstream side of the fixing nip is within the predetermined range (Step S108; YES (see FIG. 4)), the controller 90 controls the fixing section 30. In other words, the controller 90 determines to perform the second fixing speed control process (see FIG. 5) (Step S109 (see FIG. 4)).

Therefore, according to the image forming apparatus 100, since it is possible to determine to perform the second fixing speed control process in the situation in which a sheet entrance failure into the fixing nip has occurred, it is possible to appropriately control the conveyance speed (fixing speed) Vf in the fixing section 30.

Note that the description in the above embodiment is an example of the image forming apparatus according to the present disclosure, and the present disclosure is not limited thereto.

For example, in the above embodiment, the first sensor 50 is a so-called contact sensor including the arm portion (actuator) 51 and the laser sensor 52. However, a known non-contact sensor may be used (the same applies to the second sensor 60).

Further, in the above embodiment, the transfer section 40 has been described as the conveyor that conveys the sheet to the fixing section 30 according to the present disclosure, but the transfer section 40 is merely an example.

Further, in the above embodiment, the value of the elapsed time measured in Step S105 of the fixing speed control determination process (see FIG. 4) is held. However, for example, instead of the elapsed time, an average time of elapsed times when sheets of the same paper type/basis weight were passed in the past may be used.

Further, in the above embodiment, the value of the passing time measured in Step S107 of the fixing speed control determination process (see FIG. 4) is held. However, for example, instead of the passing time, an average time of passing times when sheets of the same paper type/basis weight were subjected to sheet passing in the past may be used. Alternatively, a passing time calculated based on a circumferential speed calculated from the number of rotations of a motor that drives the fixing section 30 and an average outer diameter of a fixing driving member may be used.

Further, in the above embodiment, the method for measuring the conveyance speed (fixing speed) Vf in the fixing section 30 is not particularly limited. For example, it may be a method of measuring the conveyance speed (fixing speed) Vf from the time when the sheet passes through the second sensor 60 (sheet passing duration time), or it may be a method of using the sheet speed measured in a non-contact manner by a laser Doppler velocimeter, or the like.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image forming apparatus comprising:
a fixer that fixes a toner image formed on a sheet;
a sensor that is provided on a downstream side of a fixing nip of the fixer in a sheet conveyance direction, and detects the sheet conveyed thereto; and
a hardware processor that controls the fixer,
wherein based on a detection result obtained by the sensor detecting a first sheet having passed through the fixer, the hardware processor controls the fixer such that a second sheet is conveyed at a predetermined conveyance speed, the second sheet being conveyed after the first sheet.

2. The image forming apparatus according to claim 1, wherein the hardware processor controls the fixer such that the second sheet is conveyed at the predetermined conveyance speed for a certain period of time after the second sheet enters the fixing nip of the fixer.

3. The image forming apparatus according to claim 1, comprising a conveyor that conveys the sheet to the fixer,
wherein the hardware processor controls the fixer such that the second sheet, which is conveyed after the first sheet, is conveyed at the predetermined conveyance speed for a certain period of time after the second sheet enters the fixing nip of the fixer, the predetermined conveyance speed being faster than a conveyance speed of the conveyor.

4. The image forming apparatus according to claim 1, wherein the hardware processor
obtains sheet information, image information and mode information for each sheet that is conveyed, and
controls the fixer in response to at least one of the sheet information, the image information or the mode information being identical between the second sheet and the first sheet.

5. The image forming apparatus according to claim 3, comprising a loop detector that is provided between the fixer and the conveyor and detects a curved shape of the sheet that passes through between the fixer and the conveyor,
wherein the hardware processor controls the fixer during a period from when the sheet enters the fixing nip of the fixer to when the loop detector detects that the curve of the sheet is eliminated.

6. The image forming apparatus according to claim 3, wherein the hardware processor controls the fixer so as to keep the conveyance at a set fixing speed until a period calculated from the detection result by the sensor on the downstream side of the fixing nip and a speed faster than the conveyance speed of the conveyor elapses.

7. The image forming apparatus according to claim 3, wherein the hardware processor determines whether to control the fixer based on a time from a timing at which the sheet passes through the conveyor to a timing at which the sheet reaches the sensor on the downstream side of the fixing nip and a time during which the sheet is passing through the sensor on the downstream side of the fixing nip.

8. The image forming apparatus according to claim 7, wherein the hardware processor controls the fixer in response to the time from the timing at which the sheet passes through the conveyor to the timing at which the sheet reaches the sensor on the downstream side of the fixing nip being longer than a predetermined time and the time during which the sheet is passing through the sensor on the downstream side of the fixing nip being within a predetermined range.
